(19) United States
(12) Patent Application Publication
(10) Pub. No.: US 2026/0075678 A1
(43) Pub. Date: Mar. 12, 2026

(54) METHODS, ARCHITECTURES, APPARATUSES AND SYSTEMS DIRECTED TO DISCONTINUOUS RECEPTION AND LOGICAL CHANNEL PRIORITIZATION BASED ON L1-INDICATED HARQ STATE INFORMATION

(71) Applicant: INTERDIGITAL PATENT HOLDINGS INC., Wilmington, DE (US)

(72) Inventors: Dylan Watts, Montreal (CA); Moon-il Lee, Melville, NY (US); Janet Stern-Berkowitz, Little Neck, NY (US); Oumer Teyeb, Montreal (CA); Brian Martin, Farnham (GB)

(21) Appl. No.: 19/116,793

(22) PCT Filed: Sep. 28, 2023
(86) PCT No.: PCT/US2023/033944

§ 371 Date: Mar. 28, 2025

Related U.S. Application Data
(60) Provisional application No. 63/410,791, filed on Sep. 28, 2022.

(51) Int. Cl. H04W 76/28; H04L 1/1812; H04W 72/232

(52) U.S. Cl. CPC H04W 76/28; H04L 1/1812; H04W 72/232

(57) ABSTRACT

Methods, architectures, apparatuses, and systems directed to discontinuous reception (DRX) are described herein. In an embodiment, a method implemented in a wireless transmit/receive unit (WTRU) may include receiving configuration information indicating (1) a downlink control information (DCI)-based indication of hybrid automatic repeat request (HARQ) state and (2) a first HARQ state associated with a HARQ process. The method may include performing a first discontinuous reception (DRX) operation based on the first HARQ state. The method may include receiving a DCI and determining that the DCI may indicate a second HARQ state associated with the HARQ process, based on the configuration information indicating that DCI-based indication of HARQ state may be enabled. The method may include performing a second DRX operation associated with the HARQ process based on the second HARQ state.

### CROSS-REFERENCE TO RELATED APPLICATIONS

This application claims the benefit of U.S. patent application Ser. No. 63/410,791 filed Sep. 28, 2022, which is incorporated herein by reference in its entirety.

### TECHNICAL FIELD

The present disclosure is generally directed to the fields of communications, software and encoding, including, for example, methods, architectures, apparatuses, systems directed to discontinuous reception (DRX) and logical channel prioritization (LCP).

### BACKGROUND

Non-terrestrial networks (NTN) may facilitate deployment of wireless networks in areas where land-based antennas may be impractical, for example, due to geography or cost. For example, NTN may be coupled with terrestrial networks to enable coverage of third generation partnership project (3GPP) 5G networks. Initial 3GPP Rel-17 NTN deployments may support basic talk and text. Further releases coupled with the proliferation of next-generation low-orbit satellites may be expected to enable enhanced services such as web browsing. Embodiments described herein have been designed with the foregoing in mind.

### SUMMARY

Methods, architectures, apparatuses, and systems directed to adapt DRX and LCP based on any of downlink control information (DCI) and physical layer (L1) based indication of whether hybrid automatic repeat request (HARQ) feedback is enabled or disabled are described herein. In an embodiment, a method may be implemented in a wireless transmit/receive unit (WTRU). The method may include receiving downlink control information indicating HARQ state information and performing discontinuous reception (DRX) based on the HARQ state information. In an embodiment, a WTRU may be configured to receive downlink control information indicating HARQ state information and to perform DRX based on the HARQ state information.

In an embodiment, a method implemented in a WTRU is described herein. The method may include receiving configuration information indicating (1) a DCI-based indication of HARQ state and (2) a first HARQ state associated with a HARQ process. The method may include performing a first DRX operation based on the first HARQ state. The method may include receiving a DCI and determining that the DCI may indicate a second HARQ state associated with the HARQ process, based on the configuration information indicating that DCI-based indication of HARQ state may be enabled. The method may include performing a second DRX operation associated with the HARQ process based on the second HARQ state.

In an embodiment, a WTRU including a processor and a transmitter and a receiver (e.g., a transceiver) operatively coupled to the processor is described herein. The WTRU may be configured to receive configuration information indicating (1) a DCI-based indication of HARQ state and (2) that downlink HARQ feedback may be disabled for a HARQ process. The WTRU may be configured to perform a first discontinuous reception (DRX) operation with disabled downlink HARQ feedback. The WTRU may be configured to receive a DCI and to determine that the DCI may indicate that downlink HARQ feedback may be enabled for the HARQ process, based on the configuration information indicating that DCI-based indication of HARQ state may be enabled. The WTRU may be configured to perform a second DRX operation with enabled downlink HARQ feedback, where monitoring to receive a retransmission may be delayed based on a WTRU to base station round trip time.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of the different interfaces in a non-terrestrial network;

FIG. 3 is a diagram illustrating an example of a user plane and a control plane protocol stack for a transparent payload system;

FIG. 4 is a system diagram illustrating examples of DRX adaptations based on HARQ feedback state and HARQ feedback mode;

FIG. 5 is a system diagram illustrating an example of LCP adaptation;

FIG. 6 is a system diagram illustrating an example method for adapting DRX based on L1 indication;

FIG. 7 is a system diagram illustrating an example method for adapting DRX based on L1 indication;

FIG. 8 is a diagram illustrating an example method for adapting DRX based on L1 indication; and

FIG. 9 is a diagram illustrating an example method for adapting DRX based on L1 indication.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

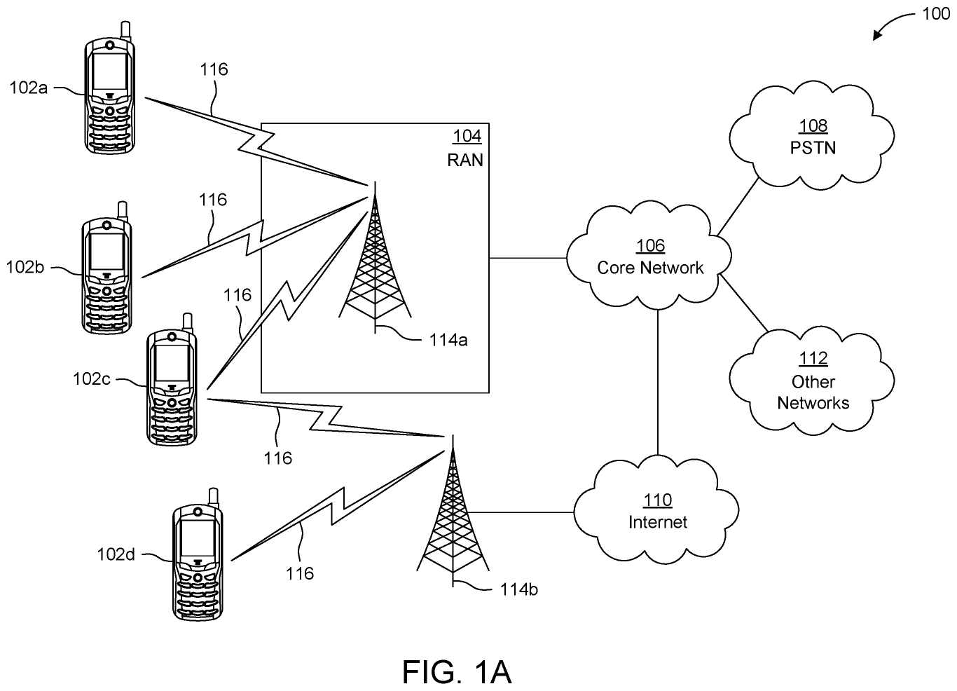

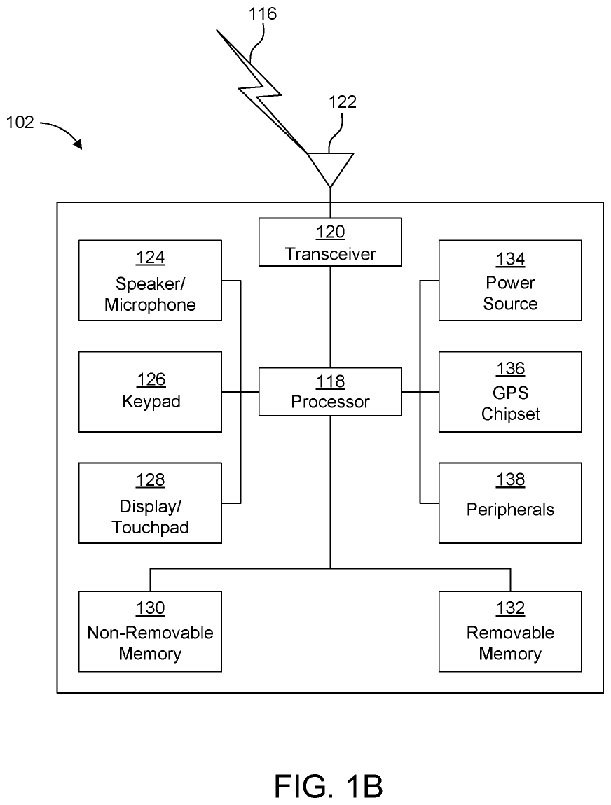

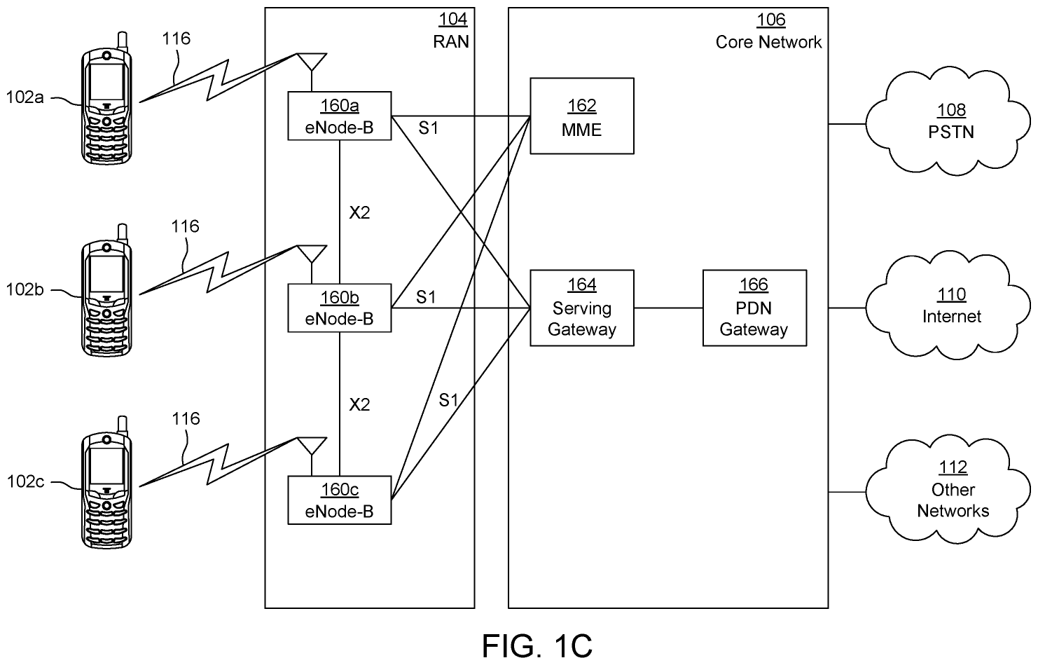

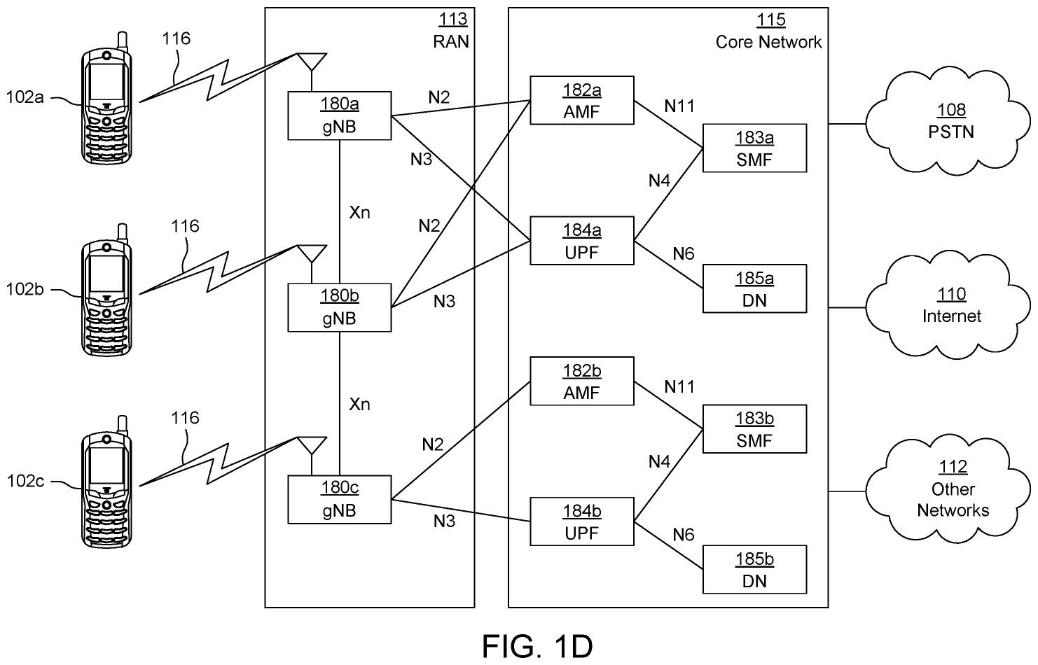

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “serving base station”, “base station”, “gNB”, collectively “gNB” may be used interchangeably to designate any network element such as e.g., a network element acting as a serving base station. Embodiments described herein are not limited to gNBs and are applicable to any other type of base stations.

For the sake of clarity, satisfying, failing to satisfy a condition (e.g., criteria) and “configuring condition parameter(s) are described throughout embodiments described herein as relative to a threshold (e.g., greater or lower than) a (e.g., threshold) value, configuring the (e.g., threshold) value, etc.). For example, satisfying a condition (e.g., criteria) may be described as being above a (e.g., threshold) value, and failing to satisfy a condition (e.g., criteria) may be described as being below a (e.g., threshold) value. Embodiments described herein are not limited to threshold-based conditions (e.g., criteria). Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

### Examples of Non-Terrestrial Networks

Non-terrestrial networks (NTN) may facilitate deployment of wireless networks in areas where land-based antennas may be impractical, for example, due to any of geography and cost. For example, NTN may be coupled with terrestrial networks to enable (e.g., truly ubiquitous) coverage of 5G networks. Initial Rel-17 NR NTN deployments may support (e.g., basic) talk and text. Further releases coupled with the proliferation of next-generation low-orbit satellites may be expected to enable enhanced services such as e.g., web browsing.

An NTN may comprise any of an aerial and a space-borne platform which, via a gateway (GW), may transport (e.g., transmit) signals received from a land-based based gNB to a WTRU and vice-versa. Rel-17 NR NTN supports power class 3 WTRU with omnidirectional antenna and linear polarization, or a very small aperture antenna (VSAT) terminal with directive antenna and circular polarization. Support for LTE-based narrow-band IoT (NB-IoT) and enhanced machine type communication (eMTC) type devices may be standardized in Rel-17, based on recommendations from 3GPP TR 36.736 “Solutions for NR to support non-terrestrial networks (NTN)” v16.1.0. For example, any Rel-17 NTN WTRU may be global navigation satellite system (GNSS) capable for any device type.

Aerial and/or space-borne platforms may be classified based on their orbit. For example, NR systems may be based on any of low-earth orbit (LEO) satellites with altitude range of e.g., 300-1500 km and geostationary earth orbit (GEO) satellites with altitude at 35 786 km. NR systems may be compatible with other satellite platforms (e.g., classifications) such as e.g., medium-earth orbit (MEO) satellites with altitude range of e.g., 7000-25000 km and high-altitude platform stations (HAPS) with altitude of e.g., 8-50 km. Satellite platforms may be further classified as having any of a “transparent” and a “regenerative” payload. Transparent satellite payload systems may implement frequency conversion and RF amplification in uplink and downlink, for example, with one or more transparent satellites connected to one land-based gNB. Regenerative satellite payload systems may implement any of a full gNB and gNB distributed unit (DU) onboard the satellite. Regenerative payload systems may perform, for example, digital processing on the signal e.g., including any of demodulation, decoding, re-encoding, re-modulation and filtering.

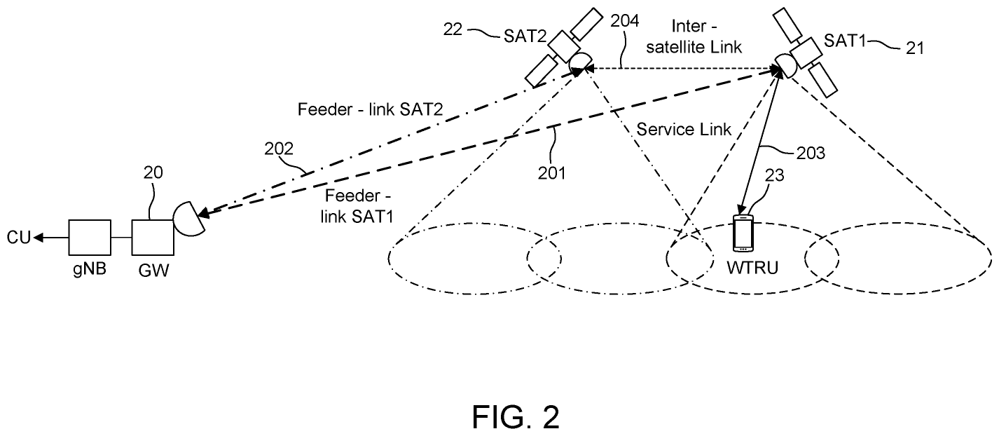

FIG. 2 is a system diagram illustrating an example of the different interfaces in a non-terrestrial network. For example, an NTN network may comprise a wireless link between the GW 20 and a satellite 21, 22, which may be referred to herein as a feeder link 201, 202. For example, the NTN network may comprise a radio link between satellite 21, 22 and the WTRU 23, which may be referred to herein as service link 203. The NTN network may comprise a transport link between satellites 21, 22, which may be referred to as inter-satellite link (ISL) 204. There may be an ISL (e.g., only) in regenerative payload systems which may be compatible with any of a 3GPP radio interface and a proprietary (e.g., optical) interface.

Depending on the satellite payload configuration (e.g., transparent or regenerative), different 3GPP interfaces may be used for a (e.g., each) radio link. In a transparent payload system, the NR-Uu radio interface may be used for the service link and the feeder-link. For a regenerative payload system, the NR-Uu interface may be used on the service link, and a satellite radio interface (SRI) may be used for the feeder-link. There is no description of ISLs in 3GPP Rel-17.

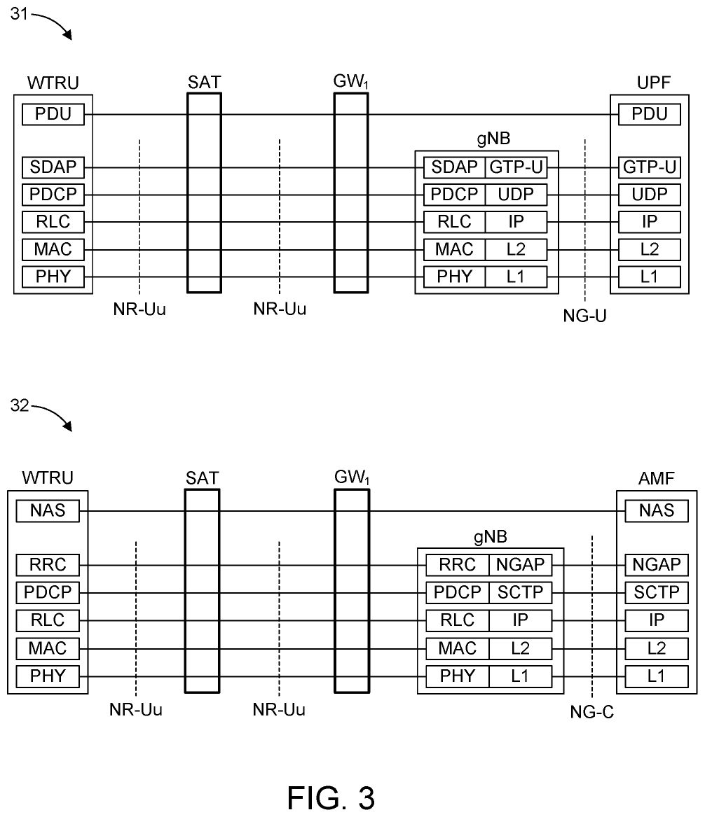

FIG. 3 is a diagram illustrating an example of user plane (UP) 31 and control plane (CP) 32 protocol stack for a transparent payload system. Protocol stacks for other types of payload systems are described in 3GPP TR 38.821 “Solutions for NR to support non-terrestrial networks (NTN)”, v16.1.0 in section 5.1 and 5.2.

An NTN satellite may support one or more cells, and a cell may comprise one or more satellite beams. Satellite beams may cover a footprint on earth (e.g., such as a terrestrial cell) which may range in diameter from e.g., 100 to 1000 km in LEO deployments, and from 200 to 3500 km diameter in GEO deployments. Beam footprints in GEO deployments may remain fixed relative to earth, and in LEO deployments the area covered by a beam (e.g., cell) may change over time based on satellite movement. This beam movement may be referred to herein as “earth moving” in a case where the LEO beam may move continuously across the earth, or as “earth fixed” in a case where the beam may be steered to remain covering a fixed location until a new cell may overtake the coverage area in e.g., a discrete and coordinated change.

Based on any of the altitude of NTN platforms and beam diameter, the round-trip time (RTT) and maximum differential delay may be larger than that of terrestrial systems. For example, in a transparent NTN deployment, RTT may range from 25.77 ms (for LEO at 600 km altitude) to 541.46 ms (for GEO) and maximum differential delay may range from 3.12 ms to 10.3 ms. The RTT of a regenerative payload system may be half of that of a transparent payload system. Indeed, a transparent configuration may comprise the service and feeder links and the RTT of a regenerative payload system may involve the service link (e.g., only). For example, a WTRU may perform timing pre-compensation prior to initial access to reduce (e.g., minimize) impact to existing NR systems (e.g., such as to avoid preamble ambiguity or properly time reception windows).

For example, the WTRU may obtain its position via GNSS, and may obtain the feeder-link (or common) delay and satellite position via satellite ephemeris data to proceed with the pre-compensation procedure. The satellite ephemeris data may be periodically broadcast in system information, and may contain any of the satellite speed, direction, and velocity. For example, the WTRU may determine (e.g., estimate) the distance (and e.g., the delay) from the satellite. For example, the WTRU may add the feeder-link delay component to obtain the full WTRU-gNB RTT, which may be used to offset any of timers, reception windows, and timing relations. Frequency compensation may be performed, for example, by the network.

3GPP NR Rel-17 NTN further describes WTRU mobility and measurement reporting. For example, the difference in reference signal received power (RSRP) between cell center and cell edge may not be as pronounced as in terrestrial systems. This, e.g., coupled with the larger region of cell overlap may result in 3GPP NR measurement-based mobility to be less reliable in an NTN environment. New conditional handover and measurement reporting triggers relying on location and time may allow to improve mobility management in NTN systems. Enhanced mobility may be of special interest in LEO deployments where, due to satellite movement, a stationary WTRU may perform mobility (e.g., approximately) every 7 seconds (depending on deployment characteristics).

### Examples of Disabling HARQ feedback in Rel-17 NTN

HARQ stalling may be referred to herein as (e.g., all) HARQ process identifiers (IDs) having been allocated and being pending, such that none may be re-used for new data transmission/reception. Several enhancements were introduced in Rel-17 NR NTN to avoid HARQ stalling due to increased propagation delays. For example, the ability to disable HARQ feedback may allow HARQ process IDs to be (e.g., immediately) used after a transmission for new data transmission, such that HARQ stalling may be prevented.

A e.g., radio resource control (RRC) configuration (e.g., information), which may be referred to herein as downlinkHARQ-feedbackDisabled may indicate whether downlink (DL) HARQ feedback is enabled or disabled. For example, the (e.g., RRC) configuration downlinkHARQ-feedbackDisabled, may be configured (e.g., HARQ feedback may be disabled) per serving cell. For example, a WTRU may receive (e.g., semi-static) configuration information indicating per HARQ-process ID whether the WTRU may generate HARQ feedback for a DL assignment addressed to the HARQ process ID. Similarly, e.g., RRC configuration information, which may be referred to herein as uplinkHARQ-Mode may be applicable to UL HARQ processes. For example, the (e.g., RRC) configuration information uplinkHARQ-Mode may be configured (e.g., uplink HARQ mode A may be configured) per serving cell. For example, a WTRU may receive (e.g., semi-static) configuration information indicating per HARQ process ID whether a HARQ process may be configured as HARQ mode A or HARQ mode B. For example, the network may provide an UL grant independently from the HARQ mode configuration. For example, HARQ mode A may be more suited to HARQ processes with UL HARQ retransmission enabled (e.g., to HARQ processes where monitoring for HARQ retransmission grant information may be enabled), and HARQ mode B may be more suited to HARQ processes with UL HARQ retransmission disabled (e.g., to HARQ processes where monitoring for HARQ retransmission grant information may be disabled) based on WTRU DRX behavior, as further detailed in embodiments described herein.

The terms “HARQ mode A”, “uplink HARQ mode A”, “HARQmodeA” and “first uplink HARQ mode” collectively “HARQ mode A” may be used interchangeably throughout embodiments described herein to refer to an uplink HARQ mode that may be more suited to HARQ processes with UL HARQ retransmission enabled (e.g., where monitoring for HARQ retransmission grant information may be enabled). The terms “HARQ mode B”, “uplink HARQ mode B”, “HARQmodeB” and “second uplink HARQ mode” collectively “HARQ mode B” may be used interchangeably throughout embodiments described herein to refer to an uplink HARQ mode that may be more suited to HARQ processes with UL HARQ retransmission disabled (e.g., where monitoring for HARQ retransmission grant information may be disabled).

For example, DL HARQ feedback may be any of enabled and disabled via semi-static RRC configuration for at least enhanced machine type communication (eMTC) devices.

### Examples of DRX Adaptations

The timing for reusing a HARQ process ID for a subsequent transmission may be based on whether DL HARQ feedback is enabled or disabled. For example, a HARQ process with DL HARQ feedback enabled may use at least one RTT for the WTRU to provide HARQ feedback and receive a subsequent (e.g., re) transmission, whereas a WTRU process with disabled DL HARQ feedback may be reused (e.g., immediately) after the (e.g., last) transmission.

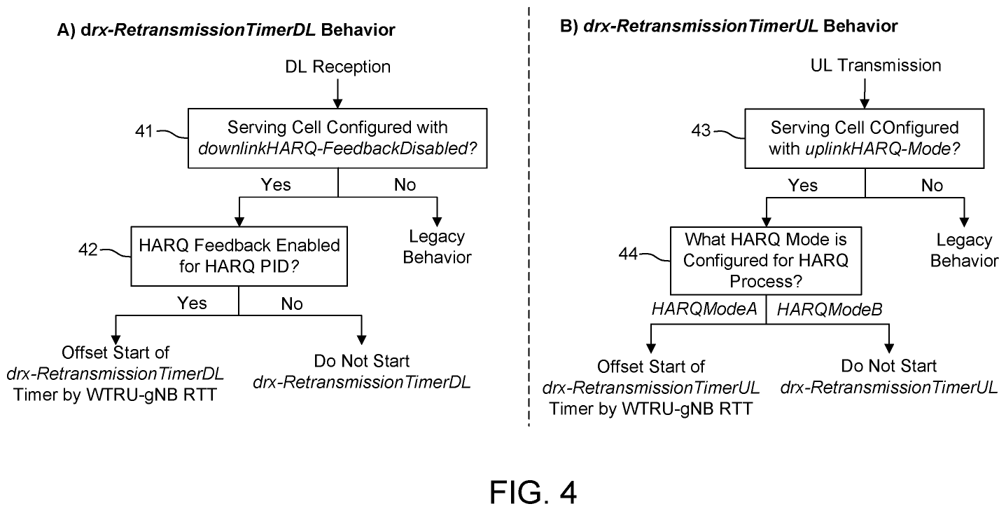

FIG. 4 is a system diagram illustrating examples of DRX adaptations based on downlink HARQ feedback state and uplink HARQ feedback mode.

As shown at 41, the WTRU may determine whether the serving cell is configured with downlink HARQ feedback disabled. In a case where the WTRU determines that the serving cell is configured with downlink HARQ feedback disabled, the WTRU may determine, as shown at 42 whether HARQ feedback is enabled for a HARQ process (e.g., ID). In a case where the WTRU determines that HARQ feedback is enabled for the HARQ process (e.g., ID), the WTRU may start a retransmission timer, after a transmission (which may be referred to herein as drx-Retransmission TimerDL), which may be delayed by an offset corresponding to the WTRU-gNB RTT, such that the WTRU may be awake and monitoring the physical downlink control channel (PDCCH) at the appropriate time (e.g., for receiving an upcoming transmission). For example, for HARQ processes with disabled HARQ feedback, the WTRU process may not proceed any subsequent retransmission. In this case the drx-RetransmissionTimerDL may not be started after a transmission, which may improve WTRU power saving. In a case where downlink HARQ feedback disabled is not configured for a serving cell, legacy behavior may apply.

Similarly, in the UL case, as shown at 43, the WTRU may determine whether the serving cell is configured with uplink HARQ mode. In a case where the WTRU determines that the serving cell is configured with uplink HARQ mode, the WTRU may determine, as shown at 44, which HARQ mode may be configured for HARQ process ID. For example, in a case where the WTRU is configured with uplink HARQ mode and a HARQ process is configured with HARQ mode A, the WTRU may offset (e.g., delay) the start of the DRX UL retransmission timer (which may be referred to herein as drx-RetransmissionTimerUL) by the WTRU-gNB RTT. In a case where the WTRU is configured with HARQ mode B, the WTRU may not start the DRX UL retransmission timer. In a case where uplink HARQ mode is not configured for a serving cell, legacy behavior may apply.

In embodiments described herein, the terms “drx-Retransmission TimerDL”, “DRX DL retransmission timer” and “DL retransmission timer” may be used interchangeably to refer to a period of time during which the WTRU may monitor (e.g., the PDCCH) for (e.g., receiving) a DL retransmission, e.g., as described in section 5.7 of 3GPP TS 38.321. The DL retransmission timer may be applicable, for example, per DL HARQ process.

In embodiments described herein, the terms “drx-RetransmissionTimerUL”, “DRX UL retransmission timer” and “UL retransmission timer” may be used interchangeably to refer to a period of time during which the WTRU may monitor (e.g., the PDCCH) for (e.g., receiving) a UL grant (e.g., information) for an UL retransmission. The UL retransmission timer may be applicable, for example, per UL HARQ process.

In embodiments described herein, the term “DL HARQ RTT timer” may be used to refer to a period of time after which the WTRU may monitor (e.g., the PDCCH) for (e.g., receiving) a DL assignment (e.g., information) for a HARQ retransmission, e.g., as described in section 5.7 of 3GPP TS 38.321. No DL assignment (e.g., information) for a HARQ retransmission may be expected to be received by the WTRU during that period of time. The DL HARQ RTT timer may be applicable, for example, per DL HARQ process.

In embodiments described herein, the term “UL HARQ RTT timer” may be used to refer to a period of time after which the WTRU may monitor (e.g., the PDCCH) for (e.g., receiving) a UL HARQ retransmission grant (e.g., information), e.g., as described in section 5.7 of 3GPP TS 38.321. No UL HARQ retransmission grant (e.g., information) may be expected to be received by the WTRU during that period of time. The UL HARQ RTT timer may be applicable, for example, per UL HARQ process.

### Examples of LCP Adaptations

A gNB may disable UL HARQ retransmission by sending grant information indicating a new grant with toggled new data indicator (NDI) prior to waiting for the network decoding result such that transmissions sent on (e.g., certain) HARQ processes may be less reliable than others. As discussed in embodiments described herein, UL HARQ process IDs configured with HARQ mode A may receive information indicating UL retransmission grants based on the network decoding result, and UL HARQ process IDs configured with HARQ mode B may not (e.g., subsequent grants may be any of blind retransmission grants or no retransmission grants).

Configuration of uplink HARQ mode may imply that UL grants assigned to (e.g., certain) HARQ processes may be more reliable than others. For example, a (e.g., new) LCP restriction (referred to herein as allowed HARQ mode (e.g., allowedHARQ-Mode)) may be used. An allowed HARQ mode LCP restriction (allowedHARQ-Mode) may indicate per logical channel (LCH) whether data from this LCH may be mapped to (e.g., associated with) HARQ process IDs configured with HARQ mode A or HARQ mode B. In a case where any of uplink HARQ-mode and allowed HARQ mode is not configured, legacy LCP behavior may apply.

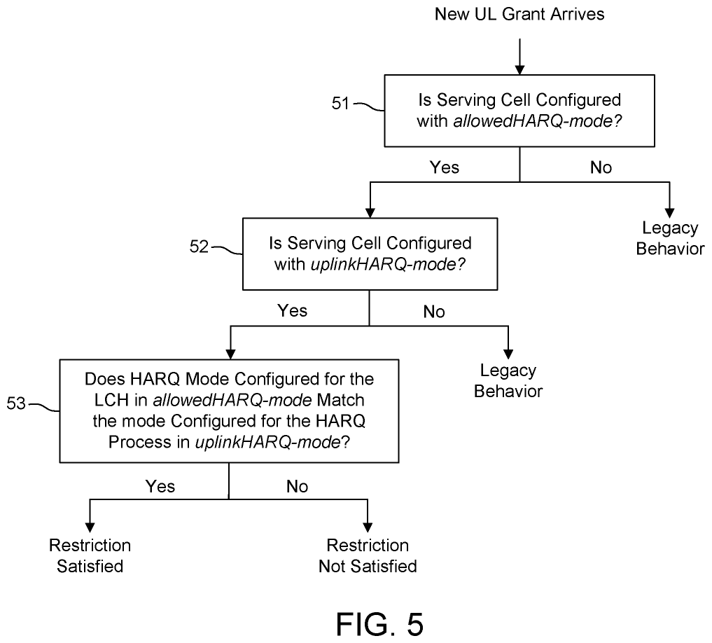

FIG. 5 is a system diagram illustrating an example of LCP adaptation. For example, a WTRU may receive grant information indicating an uplink grant for an LCH. At step 51, the WTRU may determine whether an allowed HARQ mode LCP restriction may be configured for this LCH. In a case where an allowed HARQ mode LCP restriction is configured for the LCH, the WTRU may determine, at step 52, whether an UL HARQ mode may have been configured for the HARQ process associated with the UL grant. In a case where an UL HARQ mode has been configured for the HARQ process, the WTRU may determine, at step 53, whether an allowable UL HARQ mode configured in a mapping rule may match the UL HARQ mode configured for the HARQ process, to determine whether a restriction is satisfied or not.

### Overview

Disabling HARQ feedback may have implications for any of DRX and LCP, and the adaptations (e.g., of DRX and LCP) to adjust the WTRU behavior based on the HARQ feedback state may rely on (e.g., reception of) RRC configuration information (e.g., downlink HARQ feedback disabled, uplink HARQ mode, and allowed HARQ mode). For example, (e.g., reception of) RRC configuration (e.g., information) may not be suitable for lower-capability devices such as any of reduced capability (RedCap) and narrow band internet of things (NB-IoT). For example, NB-IoT may support fewer HARQ processes (e.g., one or two), such that there may be less flexibility to have a set of HARQ processes enabled or disabled. For example, RRC reconfiguration may not be supported, such that there may be no way to change configuration after the initial connection set-up.

Embodiments described herein may allow to indicate whether HARQ feedback is any of enabled and disabled, via other means than RRC configuration information, such as e.g., DCI-based indication. Embodiments described herein may allow to adapt DRX and LCP operation for a DCI-based solution. For example, Embodiments described herein may allow to adapt any of DRX timers and LCP restrictions in a case where L1-based (e.g., DCI) indication is used to any of enable/disable DL HARQ feedback and provide (e.g., indicate) an UL HARQ mode

Embodiments are described herein for reduced capability and IoT devices. Embodiments described herein are not limited to those reduced capability and IoT devices and may be equally applicable to any device, technology, and/or environment supporting L1-based indication of HARQ feedback state information.

Throughout embodiments described herein the terminology “DCI-based indication”, “physical layer information indicating” “L1-based indication”, collectively “L1-indication” may be used interchangeably to refer to a technique for indicating a piece of information using L1 (e.g., physical layer) information. Embodiments described herein are not limited to DCI-based indication and may be applicable to any other L1-based methods capable of indicating whether downlink HARQ feedback is any of enabled and disabled, and/or indicating an uplink HARQ mode.

Throughout embodiments described herein, the terminology “HARQ state” and “HARQ feedback state” may be used interchangeably to refer to any of (i) DL HARQ feedback being enabled or disabled and (ii) UL HARQ mode (e.g., A or B) being configured, e.g., for at least one HARQ process.

Embodiments for adapting DRX and/or LCP according to L1-based indication of HARQ feedback state (e.g., whether HARQ feedback is enabled or disabled) are described herein.

### Examples of L1 Indication of HARQ Feedback State

L1 indication (e.g., how the WTRU may determine the HARQ feedback state (e.g., based on DCI)) is described herein in more detail.

In an embodiment, a WTRU may receive information indicating (e.g., an indication of) HARQ feedback state (e.g., that DL HARQ feedback may be enabled or disabled and/or that UL HARQ mode A or B may be configured) via an indication (e.g., information) in L1. The indication (e.g., information) may be explicit or implicit. The indication (e.g., information) may work independently of or in combination with one or more RRC configurations (e.g., that may be used to any of (1) enable HARQ feedback, (2) disable HARQ feedback and (3) configure HARQ mode for any of (i) a HARQ process and (ii) an LCP mapping restriction.

For example, a WTRU may receive information indicating (e.g., an indication of) a HARQ feedback state within a DCI. In an example, the indication (e.g., information) may be present within a DL assignment, wherein the indication (e.g., information) may refer to HARQ feedback behavior for the corresponding DL reception. In another example, the indication (e.g., information indicating the HARQ state) may be present in an UL grant, wherein the indicated HARQ behavior may refer to the corresponding UL transmission.

In an embodiment, a WTRU may receive information indicating (e.g., an indication of) (1) HARQ feedback status (e.g., indicating whether HARQ feedback is enabled or disabled) for the associated HARQ process and/or (2) HARQ mode behavior via DCI. The indication may represent, for example, one or more of the following information examples:

In an example, the information may indicate whether DL HARQ feedback is enabled or disabled for the scheduled physical downlink shared channel (PDSCH) in the DCI.

In another example, the information may indicate whether DL HARQ feedback is enabled or disabled for all HARQ processes.

In yet another example, the information may indicate whether DL HARQ feedback is enabled or disabled for a subset of HARQ processes, wherein the subset may be configured (e.g., indicated by receiving configuration information) via a higher layer signaling (such as e.g., RRC). For example, the WTRU may receive configuration information indicating one or more subsets of HARQ processes, where a (e.g., each) subset of HARQ processes may be configured (e.g., associated) with an index. The index may be indicated (e.g., included) in the DCI.

In yet another example, the information may indicate that DL HARQ feedback may be disabled except for PDSCH carrying a MAC control element (MAC-CE). For example, in a case where a WTRU receives this indication, the WTRU may skip HARQ feedback for a PDSCH except for the case where a PDSCH is carrying a MAC-CE.

In yet another example, the information may indicate whether DL HARQ feedback is enabled or disabled for all HARQ processes except for a HARQ process which may be used for MAC-CE transmission. The HARQ process carrying MAC-CE may be e.g., any of configured, determined, and indicated by the gNB. The HARQ process carrying MAC-CE may be e.g., implicitly determined based on the HARQ process number (such as e.g., any of the lowest HARQ process identity, the highest HARQ process identity, etc.)

In yet another example, the information may indicate UL HARQ mode A.

In yet another example, the information may indicate UL HARQ mode B.

In yet another example, the information may indicate toggles HARQ feedback behavior for this HARQ process (e.g., unless otherwise indicated, all subsequent DCIs addressed to this HARQ process may have the same HARQ feedback state).

In yet another example, the information may indicate to override RRC configuration for this HARQ process.

Throughout embodiments described herein, the terms “enabling/disabling of HARQ feedback” may be interchangeably used with “activation/deactivation of HARQ feedback”.

In an embodiment, information related to (e.g., indicating) HARQ feedback state may be indicated (e.g., transmitted) and/or a WTRU may determine HARQ feedback state via one or more of the following examples of methods.

In an example, an explicit flag within DCI may indicate an HARQ feedback state (e.g., a flag bit set to 1 may correspond with DL HARQ feedback enabled, whereas a flag bit set to 0 may correspond to HARQ feedback disabled or vice-versa. Similarly, a flag may correspond to (e.g., indicate) UL HARQ mode A or UL HARQ mode B).

In another example, an HARQ feedback state may be indicated based on DCI format. For example, one or more DCI formats may be configured (e.g., the WTRU may receive configuration information indicating one or more DCI formats). In a case where the WTRU receives a specific DCI format (e.g., a DCI format indicated by the gNB as associated with and/or corresponding to any of HARQ feedback enabling and disabling), the WTRU may determine to disable or enable HARQ feedback associated with the HARQ process based on the DCI format. For example, in a case where the WTRU receives a first DCI format (e.g., DCI format A) for PDSCH, the WTRU may determine that the associated HARQ feedback may be disabled (e.g., for subsequent DL assignment addressed to the HARQ process), and in a case where the WTRU receives a second DCI format (e.g., DCI format B) for PDSCH, the WTRU may determine that the associated HARQ feedback may be enabled (e.g., for subsequent DL assignment addressed to the HARQ process).

In yet another example, the WTRU may determine HARQ feedback state based on the radio network temporary identifier (RNTI) scrambled with cyclic redundancy check (CRC) of the scheduling DCI. For example, in a case where a DCI format scheduling PDSCH is scrambled with a first cell RNTI (C-RNTI) (e.g., C-RNTI-1), the WTRU may determine that the HARQ feedback for the scheduled PDSCH may be disabled; in a case where a DCI format scheduling PDSCH is scrambled with a second C-RNTI (e.g., C-RNTI-2), the WTRU may determine that the HARQ feedback for the scheduled PDSCH may be enabled. A WTRU may be configured with (e.g., receive configuration information indicating) one or more C-RNTIs and a (e.g., each) C-RNTI may be associated with a HARQ feedback status (or mode). In a case where a WTRU is configured with a single HARQ process, HARQ disabling may not be supported and a single C-RNTI (e.g., C-RNTI-1) may be used. In a case where HARQ disabling is not supported (e.g., based on WTRU capability), a WTRU may be configured with a single C-RNTI.

In yet another example the WTRU may determine HARQ feedback state based on the PDCCH search space. For example, one or more PDCCH search spaces may be configured (e.g., indicated by received configuration information) or used; and a (e.g., each) PDCCH search space may be associated with a HARQ feedback state (e.g., enable or disable). In a case where a WTRU receives a DCI in a first PDCCH search space (e.g., the first search space being associated with HARQ feedback enabling), the WTRU may determine that HARQ feedback may be enabled for the scheduled PDSCH. In a case where the WTRU receives a DCI in a second PDCCH search space (e.g., the second search space being associated with HARQ feedback disabling), the WTRU may determine that HARQ feedback may be disabled for the scheduled PDSCH. Throughout embodiments described herein the term “PDCCH search space” may be interchangeably used with “search space identity”, “control resource set (CORESET)”, “PDCCH candidate”, and “PDCCH search space identity”.

In yet another example the WTRU may determine HARQ feedback state based on scheduling information (e.g., transport block size (TBS), repetitions). For example, HARQ feedback status (e.g., enabling/disabling) may be determined based on scheduling parameters for the PDSCH including any of TBS, modulation and code scheme (MCS), number of repetitions, demodulation reference signal (DMRS) density, NDI, HARQ process number, number of layers, number of codewords, and DMRS port indication).

Examples of L1 indication of HARQ feedback state to higher layers Embodiments for indicating HARQ feedback state to higher layers (e.g., MAC) are described herein in more detail.

In an embodiment, a WTRU may indicate HARQ feedback state (or L1 indication) to a higher layer (e.g., always) when (e.g., after) the WTRU may receive a DL DCI which may schedule a PDSCH.

In another embodiment, a WTRU may indicate HARQ feedback state to a higher layer in a case where one or more of following conditions are met.

In an example, the WTRU may indicate a HARQ feedback state to a higher layer in a case where a HARQ feedback state indicated in DCI is different from the HARQ feedback state e.g., configured via a higher layer signaling (e.g., RRC configuration).

In another example, the WTRU may indicate a HARQ feedback state to a higher layer in a case where a HARQ feedback state indicated in DCI is different from the previous HARQ feedback state (e.g., a previously indicated HARQ feedback state). For example, a WTRU may be indicated (e.g., receive information indicating) to enable HARQ feedback for a PDSCH in DCI at a first slot and the WTRU may be indicated (e.g., receive information indicating) to disable HARQ feedback for a PDSCH in DCI at a second slot, wherein the first slot may be earlier than the second slot.

In yet another example, the WTRU may indicate HARQ feedback state to a higher layer in a case where the time slot is configured as a slot in which the WTRU may indicate HARQ feedback state to a higher layer, the configuration of the time slot for HARQ feedback state indication to a higher layer may be (e.g., according to) a periodic reporting.

In yet another example, the WTRU may indicate a HARQ feedback state to a higher layer in a case where the number of disabled (or enabled) HARQ processes satisfies a condition (e.g., is higher than a (e.g., threshold) value, wherein the (e.g., threshold) value may be any of pre-determined, configured, or indicated by the gNB.

In yet another example, the WTRU may indicate HARQ feedback state to a higher layer in a case where HARQ feedback is disabled for all HARQ processes.

In an embodiment, a WTRU may be indicated (e.g., in DCI) to report HARQ feedback state to a higher layer by the gNB.

In embodiments described herein, the terms “HARQ feedback state” may be interchangeably used with “L1 indication”, “L1 HARQ state indication”, “L1 state of HARQ feedback state”, and “L1 indication of HARQ feedback state”.

In an embodiment, the L1 indication (e.g., HARQ feedback state indicated to a higher layer) may include one or more of the following information.

In an example, the L1 indication may include information indicating whether HARQ feedback is enabled or disabled.

In another example, the L1 indication may include information indicating whether HARQ feedback status changed (e.g., from enabled to disabled, from activation to deactivation, etc.).

In yet another example, the L1 indication may include information indicating a number of disabled (or enabled) HARQ processes.

In yet another example, the L1 indication may include information indicating a list of disabled (or enabled) HARQ processes.

In yet another example, the L1 indication may include information indicating a ratio between HARQ feedback enabled and HARQ feedback disabled cases e.g., within a window.

In yet another example, the L1 indication may include information indicating the duration of the indication.

### Examples of Higher-Layer Adaptation based on L1-Indicated HARQ Feedback State

Impacts and adaptations to DRX and LCP based on L1 indication are described herein.

In an embodiment, a WTRU may adapt higher-layer procedures (e.g., any of DRX and LCP) based on HARQ feedback state indication from lower layers (e.g., L1 indication). These adaptations may allow to enable a WTRU behavior based on the indicated HARQ feedback state, for example, in the absence of a default behavior or in absence of a RRC configuration. The WTRU actions (e.g., operations) described herein may vary depending on, for example, one or more of the following:

In a first example, the WTRU actions (e.g., operations) may be based on whether an RRC configuration to enable/disable HARQ feedback may already be configured.

In a second example, the WTRU actions (e.g., operations) may be based on the indicated HARQ process.

In another example, the WTRU actions (e.g., operations) may be based on the number of HARQ processes supported by the WTRU.

In yet another example, the WTRU actions (e.g., operations) may be based on the serving cell from which the transmission carrying the indication may have been received.

In yet another example, the WTRU actions (e.g., operations) may be based on the content of the indication (e.g., whether HARQ process is indicated as having HARQ feedback enabled or disabled).

In yet another example, the WTRU actions (e.g., operations) may be based on the device type (e.g., whether the device is classified as NB-IOT, eMTC, WTRU, VSAT, or RedCap).

In yet another example, the WTRU actions (e.g., operations) may be based on characteristics of the satellite (e.g., in a case where a WTRU is connected to a non-terrestrial network, whether the satellite belonging to the serving cell is geosynchronous orbit (GSO) or non GSO).

In yet another example, the WTRU actions (e.g., operations) may be based on the (e.g., length of) WTRU-gNB RTT.

In yet another example, the WTRU actions (e.g., operations) may be based on whether the DCI indication was part of a DL assignment or UL grant.

### Examples of Maintenance of HARQ feedback State for a HARQ Process

In examples, a HARQ feedback state may be maintained in any of a new state and a variable (e.g., in a case where RRC configuration is not supported or in a case where default state is not supported). A new variable may be maintained, for example, any of (1) per HARQ process, (2) per serving cell, (3) for all HARQ processes, and (4) for HARQ processes which may not have a configured HARQ feedback state (e.g., not configured as any of enabled, disabled, HARQ mode A, and HARQ mode B).

In examples, upon reception of an L1 indication, a WTRU may set any of the state and the variable to the value (e.g., HARQ feedback enabled, HARQ feedback disabled, HARQ mode A, or HARQ mode B) indicated within the L1 indication for the corresponding HARQ processes the UL grant and/or DL assignment may be assigned to. For example, (e.g., all) subsequent UL grants and/or DL assignments addressed to that HARQ process may follow that HARQ feedback state e.g., until an L1 indication may change (e.g., toggle) the state value.

In examples, a state may apply and/or may be changed based on a subsequent transmission and/or indication from the network. For example, in a case where an L1 indication toggles the HARQ feedback and/or HARQ mode, the WTRU may update the HARQ state after acknowledgment and/or transmission of corresponding UL transmission (e.g., in a case where the L1 indication was provided via UL grant), reception of DL HARQ feedback (indicated DL assignment), and/or reception of the corresponding DL transmission associated with the DL assignment.

### Examples of DRX Adaptation Based on Indication Within DL Assignment

In examples, a WTRU and/or MAC entity may adapt DRX behavior based on an indication from lower layers (e.g., any of L1 and L2). For example, upon reception of a DL assignment carrying the L1 indication and/or upon reception of the corresponding DL transmission, in a case where the L1 indication indicates that DL HARQ feedback is enabled, the WTRU may, for example, perform one or more of the following examples of operation.

In an example of operation, the WTRU may extend the length of a DL HARQ RTT timer by at least the WTRU-gNB RTT.

In another example of operation, the WTRU may offset the start of a DL HARQ RTT timer by the WTRU-gNB RTT. During a period of time corresponding to the (e.g., extended, offset) DL HARQ RTT, the WTRU may, for example, not monitor the downlink control channel (e.g., PDCCH) for saving power.

In yet another example of operation, the WTRU may offset the start of a DL retransmission timer by the WTRU-gNB RTT.

In yet another example of operation, the WTRU may extend the length of a DL retransmission timer by the WTRU-gNB RTT. During a period of time corresponding to the (e.g., extended, offset) DL retransmission time, the WTRU may, for example, monitor the downlink control channel for receiving a retransmission.

In yet another example of operation, the WTRU may start a new timer (e.g., a MAC timer) with length equal to the sum of DL HARQ RTT timer and the WTRU-gNB RTT. While the timer may be running, the WTRU may not monitor the downlink control channel (e.g., PDCCH). Upon expiry of the timer, the WTRU may (e.g., start to) monitor the downlink control channel (e.g., PDCCH) e.g., and may start the DL retransmission timer.

In yet another example of operation, the WTRU may enter DRX active time. Throughout embodiments described herein “entering in DRX active time” may be referred to as monitoring the downlink control channel (e.g., PDCCH) for detecting (e.g., receiving) a transmission, e.g., directed to the WTRU.

In a case where the L1 indication states that DL HARQ feedback may be disabled (e.g., for any of the DL assignment and the HARQ process) the WTRU may, for example, perform one or more of the following examples of operation.

In an example of operation, the WTRU may not start a DL HARQ RTT timer.

In another example of operation, the WTRU may not start a DL retransmission timer. For example, the WTRU may monitor the downlink control channel (e.g., PDCCH) based on other DRX timers, e.g., different from the DL HARQ RTT timer and/or the DL retransmission timer, such as e.g., any of the inactivity timer and DL retransmission timers associated with other HARQ processes.

In yet another example of operation, the WTRU may enter DRX active time (e.g., and may start the DL retransmission timer).

In yet another example of operation, the WTRU may start a new timer (e.g., while this timer may be running, the WTRU may monitor PDCCH).

### Examples of DRX Adaptation Based on an Indication Within UL Grant

In examples, a WTRU and/or a MAC entity may adapt DRX behavior based on information (e.g., an indication) from lower layers provided within (e.g., received in) an UL grant. The indication (e.g., physical layer information, L1 indication) may state (e.g., indicate), for example, any of (i) that UL HARQ retransmission may be enabled, (ii) that UL HARQ retransmission may be disabled, (iii) that DRX may be adapted based on HARQ mode A, and (iv) that DRX may be adapted based on HARQ mode B.

In a case where the L1 indication states (e.g., indicates) that UL HARQ retransmission may be enabled and/or that DRX may be adapted based on HARQ mode A, upon transmission of the corresponding UL transmission indicated within the UL grant, the WTRU may, for example, perform one or more of the following operations.

In an example of operation, after transmitting the corresponding UL transmission indicated within the UL grant, the WTRU may extend the length of a UL HARQ RTT timer by the WTRU-gNB RTT.

In another example of operation, after transmitting the corresponding UL transmission indicated within the UL grant, the WTRU may offset the start of a UL HARQ RTT timer by the WTRU-gNB RTT. The WTRU may, for example, delay the downlink control channel monitoring (e.g., for saving power) for a period of time corresponding to the (e.g., extended, offset) UL HARQ RTT timer.

In yet another example of operation, after transmitting the corresponding UL transmission indicated within the UL grant, the WTRU may offset the start of a UL retransmission timer by the WTRU-gNB RTT.

In yet another example of operation, after transmitting the corresponding UL transmission indicated within the UL grant, the WTRU may extend the length of a UL retransmission timer by the WTRU-gNB RTT. The WTRU may, for example, monitor the downlink control channel (e.g., for receiving any of an acknowledgement and HARQ retransmission grant information) for a period of time corresponding to the (e.g., extended, offset) UL retransmission timer. The WTRU may, for example, retransmit the UL transmission in a case where no acknowledgement is received within the period of time.

In yet another example of operation, after transmitting the corresponding UL transmission indicated within the UL grant, the WTRU may start a new timer (e.g., a MAC timer).

In yet another example of operation, after transmitting the corresponding UL transmission indicated within the UL grant, the WTRU may enter DRX active time. The new timer (e.g., MAC timer) may have a length equal to a sum of the UL HARQ RTT timer and the WTRU-gNB RTT. While the timer may be running (e.g., during a period of time corresponding to the new timer), the WTRU may not (e.g., be expected to) monitor the downlink control channel (e.g., PDCCH). Upon expiry of the new timer, (e.g., after an amount of time corresponding to the new time may have elapsed), the WTRU may (e.g., start to) monitor the downlink control channel (e.g., PDCCH), e.g., and may start the UL retransmission timer.

In a case where the L1 indication states (e.g., indicates) that UL HARQ retransmission may be disabled and/or that DRX may be adapted based on HARQ mode B, upon transmission of the corresponding UL transmission indicated within the UL grant, the WTRU may, for example, perform one or more of the following operations.

In an example of operation, after transmission of the corresponding UL transmission indicated within the UL grant, the WTRU may not start a UL HARQ RTT timer.

In another example of operation, after transmission of the corresponding UL transmission indicated within the UL grant, the WTRU may not start a UL retransmission timer. For example, the WTRU may monitor the downlink control channel (e.g., PDCCH) based on other DRX timers, e.g., different from the UL HARQ RTT timer and/or the UL retransmission timer, such as e.g., any of the inactivity timer and retransmission timers associated with other HARQ processes.

In yet another example of operation, after transmission of the corresponding UL transmission indicated within the UL grant, the WTRU may enter DRX active time (e.g., not start the UL retransmission timer).

In yet another example of operation, after transmission of the corresponding UL transmission indicated within the UL grant, the WTRU may start a new timer, during which the WTRU may monitor the downlink control channel (PDCCH).

### Examples of Duration of L1-Based DRX Adaptation

In an embodiment, the WTRU may apply the adapted DRX behavior (e.g., adapt DRX operation) for e.g., any of a specific duration, one or more transmissions, and one or more HARQ processes. For example, the WTRU may adapt the DRX behavior based on L1 indication according to one or more of the following examples.

In a first example, the WTRU may adapt the DRX behavior for the transmission scheduled by the UL grant and/or DL assignment including the L1 indication.

In another example, the WTRU may adapt the DRX behavior for the next X transmissions and/or receptions for and/or assigned to the HARQ process, where X may be any (e.g., fixed integer number).

In yet another example, the WTRU may adapt the DRX behavior for (e.g., all) transmissions for a specific HARQ process (e.g., the WTRU may adapt DRX behavior based on the L1 indication until a subsequent L1 indication addressed to the same HARQ process may be received, wherein the L1 indication may indicate to change the DRX behavior).

In yet another example, the WTRU may adapt the DRX behavior for (e.g., all) HARQ processes belonging to a serving cell.

In yet another example, the WTRU may adapt the DRX behavior for (e.g., all) HARQ processes belonging to a MAC entity.

In yet another example, the WTRU may adapt the DRX behavior for (e.g., all) UL HARQ processes belonging to (e.g., all) serving cells or MAC entities.

In yet another example, the WTRU may adapt the DRX behavior for a configured and/or indicated duration. For example, the WTRU may have received information indicating a duration over which DRX adaptation may be performed.

In an embodiment, the WTRU may determine to apply one or more of the behaviors according to any embodiment described herein based on, for example, one or more of (i) an explicit indication e.g., from lower layers (e.g., receiving explicit information indicating the one or more behaviors), (ii) receiving (e.g., RRC configuration) information indicating the one or more behaviors to be applied, (iii) the number of HARQ processes, and (iv) whether the HARQ process is an UL or DL HARQ process.

### Examples of Configuration of L1-Based DRX Adaptation

In an embodiment, the WTRU may determine whether to adapt DRX behavior based on L1 indication (e.g., indication within DCI) or not based on (e.g., explicit) configuration information. For example, a WTRU may receive configuration information e.g., via RRC indicating to enable or disable L1-based DRX adaptation. In embodiments described herein, the terminology “enabling/disabling L1-based DRX adaptation” and “enabling/disabling L1-based indication of HARQ state” may be used interchangeably to refer to enabling/disabling an operation mode for a WTRU where HARQ state may be adjusted (e.g., modified) based on a L1-based indication. This configuration information may indicate that DRX may be adapted for all HARQ processes, or on a per HARQ process granularity (e.g., level, basis). This configuration information may be combined, for example, with other configuration information (e.g., such as downlink HARQ feedback disabled information) indicating whether HARQ feedback may be enabled or disabled per HARQ process.

In an embodiment, (e.g., RRC) configuration information may include an additional field (e.g., element) indicating to enable/disable DL HARQ feedback. For example, (e.g., RRC) configuration information may indicate three states: 1) DL HARQ feedback enabled; 2) DL HARQ feedback disabled; and 3) DL HARQ feedback controlled by L1-indication. In a case where a HARQ process is configured as enabled or disabled DL HARQ feedback, the WTRU may apply the behavior as indicated by the (e.g., RRC) configuration information. In a case where the HARQ process is configured with HARQ feedback controlled by L1-indication, the WTRU may apply the DRX behavior according to the L1 indication. For example, an additional HARQ mode (e.g., HARQ mode C) may be used in the (e.g., RRC) configuration information to indicate that DRX behavior may be controlled based on an L1 indication within an UL grant.

In an embodiment, an L1 indication may have been received indicating a specific HARQ feedback behavior, and the HARQ process may already have been preconfigured with a HARQ feedback behavior (e.g., by receiving RRC configuration information). In a case where there is a conflict between the indication provided by the L1 indication and by the (e.g., RRC) configuration information, the WTRU may perform one or more of the following examples of action (e.g., operation):

In a first example of operation, the L1 indication may (e.g., always) override the RRC configuration.

In another example of operation, the L1 indication may change the RRC configuration (e.g., the L1 indication may reconfigure the RRC configuration).

In yet another example of operation, the L1 indication may override the RRC configuration subject to one or more conditions (such as e.g., based on any of a transmission priority, a number of repetitions, a TBS size, for one or more HARQ process IDs).

In another example of operation, the RRC configuration may override the L1 indication. For example, the L1 indication may be ignored based on the RRC configuration information.

The actions (e.g., operations) described herein may vary, for example, per WTRU, per HARQ process, per MAC entity, and/or per serving cell. Which action the WTRU may perform may be, for example, subject to (e.g., based on) WTRU configuration.

### Example of WTRU Behavior in Absence of L1 Indication Reception

In an embodiment, a WTRU may be capable of adapting DRX behavior. For example, the WTRU may expect to receive an L1 indication to determine how to adapt DRX behavior. For example, the WTRU may have received configuration information indicating that a HARQ process may be configured with “DL HARQ feedback controlled by L1-indication” or “HARQ mode C”. If an expected L1 indication is not received, the WTRU may assume (e.g., apply) one or more of the following:

In a case where no L1 indication is received, the WTRU may apply a default behavior. For example, a default behavior may comprise one or more DRX adaptations according to any embodiment described herein, and may be, for example, provided (e.g., received) via configuration information or indicated (e.g., within system information).

In a case where no L1 indication is received, the WTRU may apply a legacy behavior for DRX operation (e.g., WTRU-gNB RTT may not be incorporated in the DRX procedure).

In a case where no L1 indication is received, the WTRU may apply the DRX adaptation indicated by the last received L1-indication for the corresponding HARQ process.

In a case where no L1 indication is received, the WTRU may apply the DRX behavior as indicated via RRC configuration (if available).

### Examples of Logical Channel Prioritization (LCP) Adaptation

In an embodiment, a WTRU may be configured with (e.g., receive configuration information indicating) an LCP restriction which may map (e.g., associate) logical channels (LCHs) to HARQ processes configured with a (e.g., given) HARQ mode (e.g., HARQ mode A or HARQ mode B). For example, a WTRU may take an L1 indication (e.g., determined via a DCI indication within an UL grant) into account during the LCP procedure.

In an embodiment, a WTRU may adapt LCP based on physical layer information (e.g., L1-indicated HARQ state information), e.g., received in DCI.

For example, LCH mapping restriction within LCP procedure may be reused.

For example, a WTRU may interpret physical layer information (e.g., L1 indication) as indicating any of HARQ mode A and HARQ mode B. In a case where a LCH is configured with an LCH mapping restriction with restrictions to be mapped to (e.g., associated with) a (e.g., specific) HARQ mode, and the L1 indication within an UL grant matches the configured HARQ mode, the WTRU may map (e.g., associate) data from that logical channel to the UL grant. In another example, in a case where the HARQ mode indicated within the LCH mapping restriction does not match the HARQ mode indicated within the L1 indication in the UL grant, the data from that LCH may not be mapped to (e.g., associated with) that UL grant.

### Examples of DRX Adaptation Based on L1 Indication

In an embodiment, a WTRU may receive information (such as e.g., an indication and/or configuration information) indicating that HARQ state information may be provided and/or altered via L1-based indication. The information (e.g., a configuration and/or indication) may apply to any of (i) per serving cell, (ii) per HARQ process, (iii) for UL HARQ processes, (iv) for DL HARQ processes, and (v) for all HARQ processes.

A WTRU may receive information (e.g., within any of an UL grant and a DL assignment) indicating HARQ state information. HARQ state information may indicate, for example, any of (i) that HARQ feedback may be enabled, (ii) that HARQ feedback may be disabled, (iii) a HARQ mode A, (iv) a HARQ mode B, (v) that HARQ feedback and/or HARQ mode may be different from an RRC configuration, and (vi) that HARQ feedback may be different from a previously indicated HARQ feedback state information.

In examples, an indication of (e.g., information indicating) HARQ state information may be provided and/or determined via any of (i) an explicit flag within DCI, (ii) based on DCI format, (iii) based on RNTI scrambled with CRC of the scheduling DCI, (iv) the PDCCH search space, and (v) scheduling information (such as e.g., any of TBS size, repetition number). The HARQ state information may apply to, for example, any of (i) the UL transmission scheduled by the UL grant, (ii) the DL reception scheduled by the DL assignment, (iii) one or more subsequent transmissions on a HARQ process, (iv) a set of HARQ processes (such as e.g., any of one or more HARQ processes, UL HARQ processes, and DL HARQ processes).

The WTRU may indicate HARQ state information to higher layers (e.g., MAC). The indication to higher layers may comprise, for example, any of: (i) HARQ feedback state (e.g., indicating whether HARQ feedback is enabled and/or disabled), (ii) HARQ mode (e.g., indicating any of HARQ mode A and HARQ mode B), and (iii) the duration and/or granularity of indication (e.g., indicating whether this indication applies to a specific transmission and/or reception, whether this indication applies to one or more or a set of HARQ processes). For example, an indication may be provided to higher layers after the indication may have been received. In another example, the indication may be provided to higher layers conditional on, for example, any of (i) the HARQ state information being different from HARQ state information configured via higher layer signaling (such as e.g., RRC) and (ii) the HARQ state information being different from a previously indicated HARQ (e.g., feedback) state information.

After reception of physical layer information (e.g., L1 indication of HARQ state information), a WTRU may adapt DRX behavior, e.g., based on the indicated HARQ state information. In a case where the L1 indication indicates that DL HARQ feedback may be enabled, a WTRU may perform any of (i) modifying the DL HARQ RTT timer (e.g., extending length by WTRU-gNB RTT or offsetting the start by WTRU-gNB RTT); (ii) modifying the DL retransmission timer (e.g., offsetting the start by WTRU-gNB RTT or extending by WTRU-gNB RTT); (iii) starting a new timer and (iv) entering DRX active time (e.g., monitoring PDCCH). In a case where the L1 indication indicates that DL HARQ feedback may be disabled, a WTRU may perform any of (i) not starting a DL HARQ RTT timer; (ii) not starting a DL retransmission timer, not starting a new timer.

In a case where the L1 indication indicates that UL HARQ retransmission is enabled and/or indicates HARQ mode A, a WTRU may perform any of (i) modifying the UL HARQ RTT timer (e.g., extending length by WTRU-gNB RTT or offsetting the start by WTRU-gNB RTT), (ii) modifying the UL retransmission timer (e.g., offsetting the start by WTRU-gNB RTT or extending by WTRU-gNB RTT), (iii) starting a new timer, and (iv) entering DRX active time (e.g., monitoring PDCCH). In a case where the L1 indication indicates that UL HARQ retransmission is disabled and/or indicates HARQ mode B, a WTRU may perform any of (i) not starting a UL HARQ RTT timer; (ii) not starting a UL retransmission timer and not starting a new timer (such that the subsequent transmission may be transmitted).

In examples, a WTRU may apply the DRX behavior for a specific duration (such as e.g., any of (i) for a (e.g., specific) transmission and/or reception, (ii) for the next X transmissions and/or receptions, (iii) indefinitely, (iv) and until a subsequent indication may be received). Any of a L1 indication and (e.g., RRC) configuration information may indicate the duration, over which the WTRU may apply the DRX behavior. A WTRU may apply the DRX behavior for e.g., any of (i) a specific HARQ process, (ii) one or more HARQ processes (e.g., any of a set of HARQ processes, (e.g., all) UL HARQ processes, and (e.g., all) DL HARQ processes), and (iii) for (e.g., all) HARQ processes.

In a case where a L1 indication conflicts with a higher-layer configuration, a WTRU may, for example, operate according to any of (i) the L1 indication (e.g., always) overriding the RRC configuration; (ii) the L1 indication changing the RRC configuration (e.g., the L1 indication may reconfigure the RRC configuration), (iii) the L1 indication overriding the RRC configuration subject to one or more conditions (such as e.g., based on any of a transmission priority, a number of repetitions, a TBS size, one or more HARQ process IDs) and (iv) the RRC configuration overriding the L1 indication.

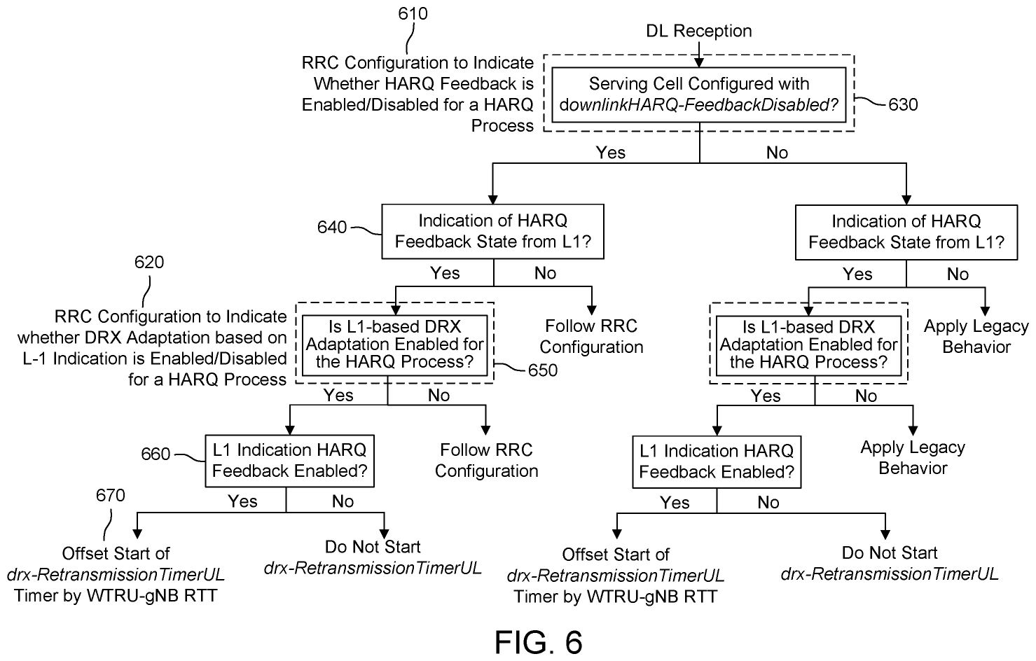

FIG. 6 is a system diagram illustrating an example method for adapting DRX based on L1 indication.

As shown at 610, a WTRU may receive first configuration information indicating whether HARQ feedback may be enabled or disabled e.g., for one or more HARQ processes.

As shown at 620, the WTRU may receive second configuration information indicating whether DRX adaptation may be enabled or disabled e.g., for one or more HARQ processes based on L1 indications. For example, the first and the second configuration information may be received in one or more (e.g., RRC) messages. For example, configuration information may be received, indicating any of (i) a L1-based indication of HARQ state, and (ii) a first HARQ state. For example, a first DRX operation may be performed based on the first HARQ state.

As shown at 630, the WTRU may determine whether the serving cell is configured with downlink HARQ feedback disabled.

As shown at 640, the WTRU may receive a L1 indication indicating a HARQ feedback state for one or more HARQ processes.

As shown at 650, the WTRU may determine whether DRX adaptation is enabled or disabled for the one or more HARQ process associated with the received L1 indication.

In a case where the WTRU determines that DRX adaptation may be enabled for the one or more HARQ process, the WTRU may determine, as shown at 660, whether the L1 indication indicates HARQ feedback enabled for the one or more HARQ processes. For example, a DCI may be received, and the WTRU may determine that the DCI may indicate a second HARQ state based on the configuration information indicating that L1-based indication of HARQ state may be enabled. For example, a second DRX operation may be performed based on the second HARQ state.

In a case where the WTRU determines that the L1 indication indicates that HARQ feedback may be enabled, the WTRU may offset the start of the DRX retransmission DL timer by the WTRU-gNB RTT as shown at 670.

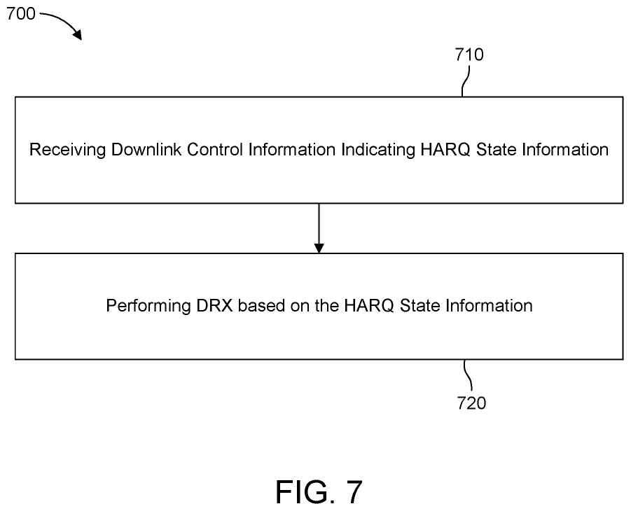

FIG. 7 is a system diagram illustrating an example method 700 for adapting DRX based on L1 indication. For example, the method may be implemented in a WTRU. As shown at 710, the WTRU may receive downlink control information indicating HARQ state information. As shown at 720, the WTRU may perform discontinuous reception based on the HARQ state information.

In various embodiments, the HARQ state information may be indicated in any of uplink grant information and downlink assignment information.

In various embodiments, the HARQ state information may indicate any of (i) that downlink HARQ feedback is enabled, ((ii) that downlink HARQ feedback is disabled, (iii) a first uplink HARQ mode and (iv) a second uplink HARQ mode.

In various embodiments, the HARQ state information may indicate a first uplink HARQ mode that may be different from a second uplink HARQ mode indicated by a previous HARQ state information.

In various embodiments, the HARQ state information may indicate a first downlink HARQ feedback state that may be different from a second downlink HARQ feedback state indicated by a previous HARQ state information.

In various embodiments, the HARQ state information may be applicable to any of (i) an uplink transmission scheduled by an uplink grant of the downlink control information, (ii) a downlink reception scheduled by a downlink assignment of the downlink control information, (iii) one or more subsequent transmissions of one or more HARQ processes.

In various embodiments, the HARQ state information may indicate that downlink HARQ feedback may be enabled, and wherein performing DRX may comprise delaying monitoring to receive a subsequent (e.g., re) transmission based on a WTRU to base station round trip time.

In various embodiments, the HARQ state information may indicate a first uplink HARQ mode, and wherein performing DRX may comprise retransmitting an uplink transmission that has not been acknowledged within a period of time including at least a WTRU to base station round trip time.

In various embodiments, the HARQ state information may indicate a second uplink HARQ mode, and wherein performing DRX may comprise monitoring a downlink control channel to receive a subsequent transmission during a time period different from an uplink retransmission time period.

In various embodiments, DRX may be performed based on the HARQ state information until subsequent HARQ state information may be indicated in subsequent downlink control information.

In various embodiments, DRX may be performed based on the HARQ state information for a period of time after which DRX may be performed according to a default behavior.

In various embodiments, the method may further comprise receiving configuration information indicating that the HARQ state information may be modified based on information indicated by the downlink control information.

In various embodiments, the HARQ state information may be applicable any of (i) per serving cell, (ii) per HARQ process, (iii) for uplink HARQ processes, (iv) for downlink HARQ processes, (iv) for all HARQ processes.

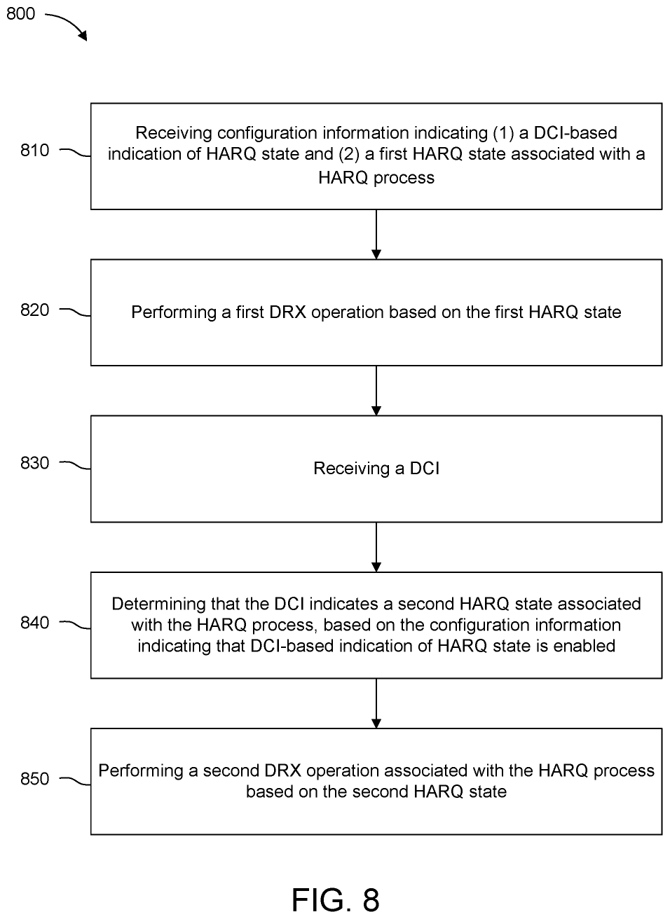

FIG. 8 is a diagram illustrating an example method 800 for adapting DRX based on L1 indication. The method 800 may be implemented in a WTRU. As shown at 810, the WTRU may receive configuration information indicating (1) a DCI-based indication of HARQ state and (2) a first HARQ state associated with a HARQ process. As shown at 820, the WTRU may perform a first DRX operation based on the first HARQ state. As shown at 830, the WTRU may receive a DCI. As shown at 840, the WTRU may determine that the DCI may indicate a second HARQ state associated with the HARQ process, based on the configuration information indicating that DCI-based indication of HARQ state may be enabled. As shown at 850, the WTRU may perform a second DRX operation (e.g., associated with the HARQ process) based on the second HARQ state.

In various embodiments, the second HARQ state may be indicated in any of uplink grant information and downlink assignment information.

In various embodiments, the second HARQ state may be different from the first HARQ state.

In various embodiments, any of the first HARQ state and the second HARQ state may indicate any of (i) that downlink HARQ feedback may be enabled, (ii) that downlink HARQ feedback may be disabled, (iii) a first uplink HARQ mode and (iv) a second uplink HARQ mode.

In various embodiments, the first uplink HARQ mode may be associated with monitoring for HARQ retransmission grant information being enabled, and the second uplink HARQ mode may be associated with monitoring for the HARQ retransmission grant information being disabled.

In various embodiments, the second HARQ state may be applicable to any of (i) an uplink transmission scheduled by an uplink grant of the DCI, (ii) a downlink reception scheduled by a downlink assignment of the DCI, (iii) one or more subsequent transmissions of the HARQ process.

In various embodiments, the first HARQ state may indicate that downlink HARQ feedback may be disabled, the second HARQ state may indicate that downlink HARQ feedback may be enabled. In various embodiments, performing the second DRX operation may comprise delaying monitoring to receive a retransmission based on a WTRU to base station round trip time.

In various embodiments, delaying monitoring to receive a retransmission may comprise delaying monitoring a physical downlink control channel based on the WTRU to base station round trip time.

In various embodiments, DRX may be performed based on the second HARQ state until the first HARQ state may be indicated in subsequent DCI.

In various embodiments, DRX may be performed according to the second HARQ state for a period of time after which DRX may be performed according to the first HARQ state.

In various embodiments, the second HARQ state may be applicable any of (i) per serving cell, (ii) per HARQ process and (iii) for all HARQ processes of the WTRU.

In various embodiments, an LCP restriction may associate one or more logical channels with an uplink HARQ mode. In various embodiments, LCP may be performed based on the configuration information indicating that DCI-based indication of HARQ state may be enabled.

In various embodiments, data of the one or more logical channels indicated in the LCP restriction may be transmitted in the second DRX operation based on the uplink HARQ mode indicated in the LCP restriction matching the second HARQ state indicated in the DCI.

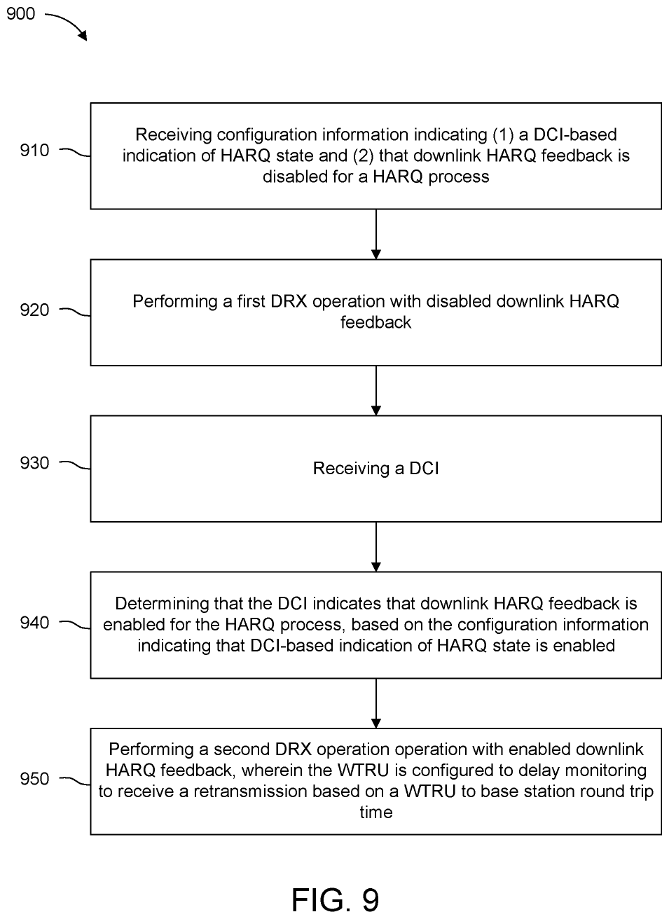

FIG. 9 is a diagram illustrating an example method 900 for adapting DRX based on L1 indication. The method 900 may be implemented in a WTRU. As shown at 910, the WTRU may receive configuration information indicating (1) a DCI-based indication of HARQ state and (2) that downlink HARQ feedback may be disabled for a HARQ process. As shown at 920, the WTRU may perform a first DRX operation with disabled downlink HARQ feedback. As shown at 930, the WTRU may receive a DCI. As shown at 940, the WTRU may determine that the DCI may indicate that downlink HARQ feedback may be enabled for the HARQ process, based on the configuration information indicating that DCI-based indication of HARQ state may be enabled. As shown at 950, the WTRU may perform a second DRX operation (e.g., associated with the HARQ process) with enabled downlink HARQ feedback, wherein the WTRU may delay monitoring to receive a retransmission based on a WTRU to base station round trip time.

In various embodiments, delay monitoring to receive a retransmission may comprise delay monitoring a physical downlink control channel based on the WTRU to base station round trip time.

In various embodiments, downlink HARQ feedback may be enabled for any of (i) a downlink reception scheduled by a downlink assignment of the DCI, and (ii) one or more subsequent transmissions of the HARQ process.

In various embodiments, DRX may be performed with enabled downlink HARQ feedback until a subsequent DCI may indicate that downlink HARQ feedback may be disabled.

In various embodiments, DRX may be performed with enabled downlink HARQ feedback for a period of time after which DRX may be performed with disabled downlink HARQ feedback.

In various embodiments, DRX operation with enabled HARQ feedback may be applicable any of (i) per serving cell, (ii) per HARQ process and (iii) for all HARQ processes of the WTRU.

The following references may have been referred to herein above and each of which is incorporated herein by reference in its entirety.

3GPP TS 38.321, “NR, Medium Access Control (MAC) protocol specification”v17.1.0.

3GPP TS 36.321, “Evolved Universal Terrestrial Radio Access (E-UTRA); Medium Access Control (MAC) protocol specification”v17.1.0.

Embodiments have been described herein with 3GPP HARQ as an example of automatic repeat request technology. Embodiments described herein may be applicable to any other kinds of automatic repeat request technologies. Embodiments have been described herein with 3GPP DRX as an example of transmit/receive technology. Embodiments described herein may be applicable to any other kinds of transmit/receive technologies.

Any characteristic, variant or embodiment described for a method is compatible with an apparatus device comprising means for processing the disclosed method, with a device comprising a processor configured to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶6 or means-plus-function claim format, and any claim without the terms “means for” is not so intended.

1. A method implemented in a wireless transmit/receive unit (WIRU), the method comprising:
receiving radio resource control (RRC) configuration information indicating (1) a downlink control information (DCI)-based indication of hybrid automatic repeat request (HARQ) state to override a RRC configuration and (2) a first HARQ state of the RRC configuration associated with a HARQ process, wherein the first HARC state indicates that downlink HARQ feedback is enabled for the HARQ process;
performing a first discontinuous reception (DRX) operation based on downlink HARQ feedback being enabled for the HARQ process;
receiving a DCI;
determining that the DCI indicates a second HARQ state associated with the HARQ process, based on the configuration information indicating that DCI-based indication of HARQ state to override the RRC configuration is enabled, wherein the second HARQ state indicates that downlink HARQ feedback is disabled for the HARQ process;
overriding the RRC configuration for the HARQ process by disabling downlink HARQ feedback for the HARQ process; and
performing a second DRX operation based on downlink HARQ feedback being disabled for the HARQ process.

2-9. (canceled)

10. The method of claim 1, wherein DRX is performed based on downlink HARQ feedback being disabled until downlink HARQ is indicated as being enabled in a subsequent DCI.

11. The method of claim 1, wherein DRX is performed with disabled downlink HARQ for a period of time after which DRX is performed with enabled downlink HARQ feedback.

12. The method of claim 1, wherein downlink HARQ feedback being disabled is applicable any of (i) per serving cell, (ii) per HARQ process and (iii) for all HARQ processes of the WTRU.

13-14. (canceled)

15. A wireless transmit/receive unit (WTRU) comprising circuitry, including a transmitter, a receiver, a processor, and a memory, configured to:
receive radio resource control (RRC) configuration information indicating (1) a downlink control information (DCI)-based indication of hybrid automatic repeat request (HARQ) state to override a RRC configuration and (2) a first HARQ state of the RRC configuration associated with a HARQ process, wherein the first HARQ state indicates the downlink HARQ feedback is enabled for the HARQ process;
perform a first discontinuous reception (DRX) operation based on downlink HARQ feedback being enabled for the HARQ process;
receive a DCI;
determine that the DCI indicates a second HARQ state associated with the HARQ process, based on the configuration information indicating that DCI-based indication of HARQ state to override the RRC configuration is enabled;
override the RRC configuration for the HARQ process by disabling downlink HARQ feedback for the HARQ process, and
perform a second DRX operation based on downlink HARQ feedback being disabled for the HARQ process.

16-20. (canceled)

21. The method of claim 1, wherein performing the second DRX operation comprises entering in DRX active time.

22. The method of claim 1, wherein performing the second DRX operation comprises not refraining from monitoring a physical downlink control channel during a base station to WTRU round trip time.

23. The WTRU of claim 15, wherein being configured to perform the second DRX operation comprises being configured to enter in DRX active time.

24. The WTRU of claim 15, wherein being configured to perform the second DRX operation comprises being configured to not refrain from monitoring a physical downlink control channel during a base station to WTRU round trip time.

25. The WTRU of claim 15, wherein DRX is performed based on downlink HARQ feedback being disabled until downlink HARQ feedback is indicated as being enabled in a subsequent DCI.

26. The WTRU of claim 15, wherein DRX is performed with disabled downlink HARQ for a period of time after which DRX is performed with enabled downlink HARQ feedback.

27. The WTRU of claim 15, wherein downlink HARQ feedback being disabled is applicable any of (i) per serving cell, (ii) per HARQ process and (iii) for all HARQ processes of the WTRU.
